(19) United States
(12) Patent Application Publication
(10) Pub. No.: US 2026/0034414 A1
(43) Pub. Date: Feb. 5, 2026

(54) GOLF DISTANCE MEASURING DEVICE

(71) Applicant: Dongkwang LEE, Gunpo-si (KR)

(72) Inventor: Dongkwang LEE, Gunpo-si (KR)

(21) Appl. No.: 18/670,084

(22) Filed: May 21, 2024

(30) Foreign Application Priority Data
Jun. 12, 2023 (KR) 10-2023-0074748
May 20, 2024 (KR) 10-2024-0065247

(51) Int. Cl. A63B 57/00; A63B 71/06; G01S 17/36

(52) U.S. Cl. CPC A63B 57/00; A63B 71/0622; G01S 17/36; A63B 2220/20; A63B 2220/805; A63B 2220/807

(57) ABSTRACT

An embodiment provides a golf distance measuring device comprising a main body formed outside a user terminal, a laser beam transceiver formed in the main body, performing transmission/reception with the user terminal, and receiving a direction of a target from the user terminal to transmit/receive a laser beam to/from the target, and a controller formed in the main body, receiving laser transmission/reception information from the laser beam transceiver, and calculating a distance to the target based on the laser transmission/reception information. Therefore, since the golf distance measuring device is attached to the smartphone and functions as a golf distance measuring system in conjunction with the smartphone, ease to carry and a slim size may be achieved.

### CROSS-REFERENCE TO RELATED APPLICATION(S)

This application is based on and claims priority under 35 U.S.C. § 119 (a) of a Korean patent application number 10-2023-0074748, filed on Jun. 12, 2023, in the Korean Intellectual Property Office, and of a Korean patent application number 10-2024-0065247, filed on May 20, 2024, in the Korean Intellectual Property Office, the disclosure of each of which is incorporated by reference herein in its entirety.

### TECHNICAL FIELD

The disclosure relates to a golf distance measuring device, and more particularly, to a golf distance measuring device, which is physically/electrically connected to a user terminal such as a smartphone, or a user terminal such as a smartphone.

### DESCRIPTION OF RELATED ART

The golf game is played on a course consisting of 9 or 18 holes, and if each player starts hitting the first stroke at the tee shot position of each hole and puts the golf ball in a hole cup installed in the green, the game ends as a hole out.

While playing such a golf game, it is very important to determine the remaining distance from the current location of the golf ball to the hole. Participants (golfers) in the golf game should know the remaining distance from the current location of the golf ball to the hole cup to select a suitable golf club.

To that end, the golfer measured the remaining distance from the current location of the golf ball to the hole cup by his own eyes based on the experience of the assistant (caddie) or a fixed structure for distance indication (e.g., flagstick), and selected the golf club according to the measured remaining distance to hit the golf ball.

However, the remaining distance measured by the caddy's experience or the golfer's eyes may differ greatly from the actual distance, causing the golfer to select an inappropriate golf club by incorrectly measuring the remaining distance, to fly the golf ball too far or too short.

To solve this problem, a GPS method of measuring the remaining distance from the current location of the golf ball or golfer to the hole cup was adopted. However, the GPS method may have many errors in the received GPS information. The location information received from GPS has an error range of 5 to 15 m in the case of the precision positioning service (PPS) used for military purposes, and an error range of 30 to 100 m in the case of the standard positioning service (SPS) provided to the private sector.

Further, while being received by the portable device, the GPS information may have many errors due to refraction in the ionosphere or atmosphere, or changes in temperature and humidity.

Therefore, a distance measuring device was provided as an individual module.

Most of distance measuring devices as individual modules adopt a mechanical method, and calculate the distance by comparing the distance scale displayed in advance on measurement screens in the lens and the image of the flagstick.

In this case, the measurer holds the lens and brings it close to her eyes to align the image of the flagstick to the measurement screen while standing on the ground. Thus, it is difficult to precisely align the flagstick to the scale even with a tiny movement of the body due to a too large magnification. Further, as the scale is not accurate, it is not easy to precisely measure the distance.

Therefore, such a mechanical device is not only inconvenient to use, but also has a large measurement error, making it difficult to actually help the game.

Further, a golf distance measuring device configured as a separate module is set for each swing during play, which delays a lot of time and makes it difficult to carry during play.

Further, a golf distance measuring device configured as a separate module is difficult to accurately capture an image of a flagstick located far away because it is difficult to have an expensive MCU, and in particular, it is cost-wise difficult to separately mount an expensive MCU for processing a complex algorithm for recognizing when wind blows or there is an obstacle.

### SUMMARY

The disclosure has been proposed to address the above issues and provides a golf distance measuring system capable of using integration of a golf distance measuring distance and a user terminal such as a smartphone.

Therefore, there is provided a golf distance measuring system capable of image analysis using a high-performance MCU of a smartphone by making a golf distance measuring device as slim as possible, physically and electrically combining the golf distance measuring device with a smartphone to interwork with an application of the smartphone.

An embodiment provides a golf distance measuring device comprising a main body formed outside a user terminal, a laser beam transceiver formed in the main body, performing transmission/reception with the user terminal, and receiving a direction of a target from the user terminal to transmit/receive a laser beam to/from the target, and a controller formed in the main body, receiving laser transmission/reception information from the laser beam transceiver, and calculating a distance to the target based on the laser transmission/reception information.

The golf distance measuring device may receive the target direction by specifying the direction of the target from a camera of the user terminal in conjunction with the user terminal.

The golf distance measuring device may further comprise a coupling terminal exposed to an outside from one end of the main body and inserted into a terminal hole of the user terminal. The coupling terminal may transfer power from the user terminal to the golf distance measuring device, transfer a target distance measurement start signal, and transmit the calculated target distance to the user terminal.

The user terminal may install and execute an application interworking with the golf distance measuring device. An image of the target, captured by the camera, may be displayed, in real time, on a display unit of the user terminal.

The user terminal may receive geographic information about a current golf course from a golf course server and specify the target in the image of the target based on the geographical information.

The user terminal may transmit the target direction to the controller through the coupling terminal. The controller may instruct the laser beam transceiver to emits the laser beam in the target direction.

The laser beam transceiver may receive the laser beam reflected from the target. The controller may calculate the target distance according to a laser beam transmission/reception time difference.

The user terminal may process and display the target distance on the display unit through the application.

The golf distance measuring device may be a terminal case in which the main body receives the user terminal and protects the user terminal from an outside. A camera hole may be formed in the terminal case to expose the camera of the user terminal. The golf distance measuring device may further comprise a telephoto lens covering the camera hole while sliding.

The golf distance measuring device may further comprise a bracket fastened to at least one surface of the user terminal and having one end connected to the main body. The golf distance measuring device may be clipped to the user terminal by the bracket.

According to an embodiment, since the golf distance measuring device is attached to a smartphone and functions as a golf distance measuring system in conjunction with the smartphone, ease to carry and slim size may be achieved.

It is also possible to display hole information about the golf course in the current round in conjunction with an application using a high-performance MCU of a smartphone, and to recommend an optimal swing direction and golf club by applying topographical characteristics, history information, weather, etc. of the golf course.

According to an embodiment, as the golf distance may be measured by a smartphone alone, it is possible to measure the distance even without an additional accessory.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 is a view schematically illustrating a golf distance measuring system according to an embodiment;

FIG. 2A is a plan view illustrating a golf distance measuring device according to a first embodiment of the disclosure;

FIG. 2B is a plan view illustrating a golf distance measuring device according to the first embodiment of the disclosure;

FIG. 3 is a block diagram illustrating the golf distance measuring system of FIG. 1;

FIG. 4 is a flowchart illustrating an operation of the golf distance measuring system of FIG. 1;

FIG. 5 is a view illustrating a golf distance display screen of the user terminal according to FIG. 4;

FIG. 6 is a view schematically illustrating a golf distance measuring device according to a second embodiment of the disclosure;

FIG. 7 is a view schematically illustrating a golf distance measuring device according to a third embodiment of the disclosure;

FIG. 8 is a flowchart illustrating operations of a golf distance measuring device;

FIG. 9 is a view schematically illustrating a golf distance measuring device according to a fourth embodiment of the disclosure;

FIG. 10 is a view schematically illustrating a golf distance measuring device according to the fourth embodiment of the disclosure; and

FIG. 11 illustrates an example of a screen displayed according to the disclosure.

### DETAILED DESCRIPTION

Various changes may be made to the disclosure, and the disclosure may come with a diversity of embodiments. Some embodiments of the disclosure are shown and described in connection with the drawings. However, it should be appreciated that the disclosure is not limited to the embodiments, and all changes and/or equivalents or replacements thereto also belong to the scope of the disclosure. Similar reference denotations are used to refer to similar elements throughout the drawings.

The terms “first” and “second” may be used to describe various components, but the components should not be limited by the terms. The terms are used to distinguish one component from another. For example, a first component may be denoted a second component, and vice versa without departing from the scope of the disclosure. The term “and/or” may denote a combination(s) of a plurality of related items as listed or any of the items.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when a component is “directly connected to” or “directly coupled to” another component, no other intervening components may intervene therebetween.

Hereinafter, preferred embodiments of the disclosure are described in detail with reference to the accompanying drawings.

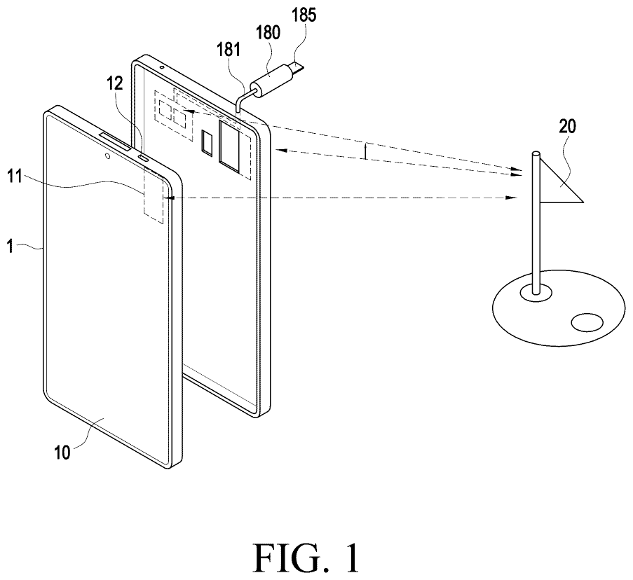

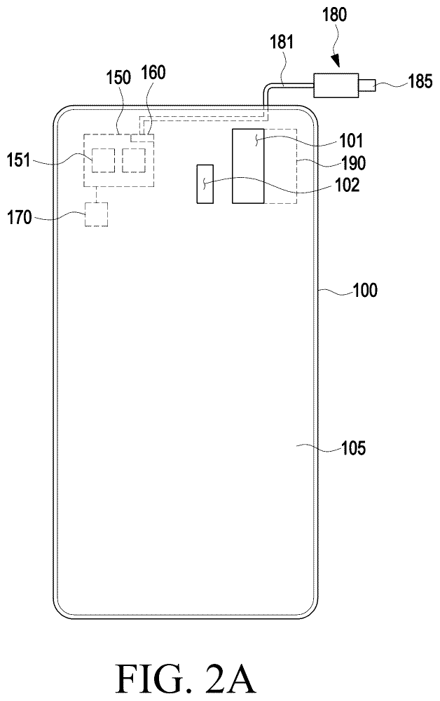

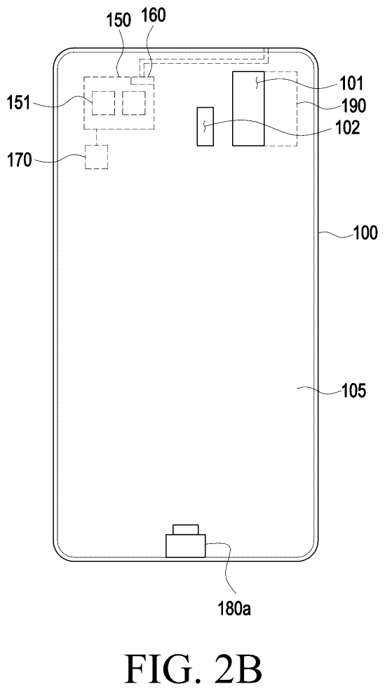

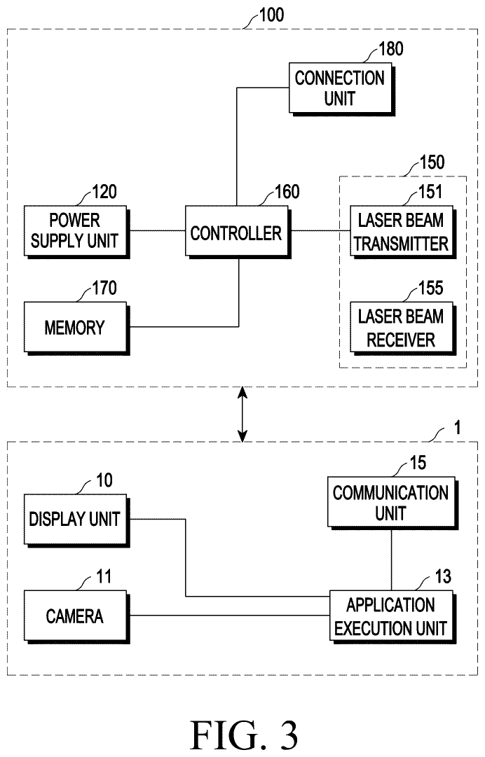

FIG. 1 is a view schematically illustrating a golf distance measuring system according to an embodiment, FIG. 2A is a plan view illustrating a golf distance measuring device according to a first embodiment of the disclosure, and FIG. 3 is a configuration view illustrating the golf distance measuring system of FIG. 1.

In order to measure the distance of a target at a long distance through a laser, the golf distance measuring system should first identify the target and then radiate the laser toward the identified target.

The golf distance measuring system according to an embodiment may implement image acquisition for grasping a target through a camera 11 of the user terminal 1 such as a smartphone.

Further, the golf distance measuring system separately includes a golf distance measuring device 100 receiving a laser module 150 capable of securing the direction of an object from the image in which the target is identified and then radiating the laser toward the direction of the object. Meanwhile, at least some functions of the golf distance measuring device 100 may be performed by the user terminal 1, and/or at least some components of the golf distance measuring device 100 may be implemented to be included in the user terminal 1, which is described below.

As shown in FIG. 1, the golf distance measuring device 100 may be provided in the form of case of the user terminal 1, e.g., a smartphone case for a smartphone. Meanwhile, implementation in the form of the smartphone case 105 is merely an example, and it will be understood by one of ordinary skill in the art that it may be implemented in the form of various accessories as well as the smartphone case 105. It will be understood by one of ordinary skill in the art that an operation based on a wireless connection is also possible, rather than being implemented by direct contact with the smartphone and/or wired connection, such as the smartphone case 105.

When the golf distance measuring device 100 is manufactured and provided in the form of the case 105 of the user terminal 1, the case 105 is physically coupled to the user terminal 1 to perform electrical connection in an integrated state, thereby implementing systemization between the two modules. Meanwhile, while the case 105 includes a housing capable of receiving the user terminal 1, power provision and/or data transmission/reception may be performed through a wireless connection. For example, the case 105 may transmit and receive data based on a wireless connection (e.g., BLE, Bluetooth, NFC, or the like, but is not limited thereto), and/or may receive power from the user terminal 1 through wireless charging.

Meanwhile, the case 105 may be implemented to further include a rechargeable battery. For example, when power may not be received from the user terminal 1, or when the magnitude of the received power is relatively small, it may be implemented to use power from an internal battery.

Specifically, since the target, e.g., the flagstick 20, is at a long distance, a camera 11 having a telephoto function is required.

A general-purpose smartphone is equipped with a camera module 11 having a telephoto function capable of observing a normal distance within a golf course. Further, using a high-performance camera 11, the functions of the camera 11, such as an image stabilization function or a target specifying function, may be utilized.

However, a user terminal 1 having a low-performance camera 11 may have a separate telephoto lens 190. This is described below.

As the user terminal 1, a tablet PC or the like may be used as well as a smartphone, but a smartphone is mainly applied since ease to carry is required as a major feature.

An application interworking with the golf distance measuring system is installed in the user terminal 1.

The application may identify round history information about a corresponding user of the corresponding user terminal 1 and make each recommendation based thereon. The application may interwork with a plurality of golf course management servers and may interwork with other user terminals.

The application may receive, from the plurality of golf course management servers, information related to a corresponding golf course, e.g., the golf course, geographical characteristics of each hole (for example, grass length, altitude, obstacle information such as bunker, etc.), user history information about the corresponding golf course, and the like.

The application may receive information about climatic characteristics such as current wind direction, temperature, illuminance, and the like, and may reflect the information and provide the information together when providing the information about each hole.

The application may obtain the image of the target, e.g., the flagstick 20, through the camera 11 at each hole, and extract the target by analyzing the image, thereby specifying the presence and direction of the target.

The application may provide information about a specific target and transfer a distance measurement start signal to the golf distance measuring device 100 to radiate a laser beam to the specific target.

The application may receive distance information to the target calculated by the laser beam reflected from the target, process the distance information to the target, and provide the processed distance information to the display unit 10.

The driving of the application and the driving of the image analysis algorithm may be provided using a processor of a smartphone.

Referring to FIGS. 1 and 2A, the golf distance measuring device 100 may be provided in the form of the case 105 of the user terminal 1.

The case-type golf distance measuring device 100 includes a main body 105 for receiving the user terminal 1, and the main body 105 includes a camera hole 101 for opening the camera module 11 to correspond to the location of the camera 11 of the smartphone. In this case, a flash hole 102 may be further formed adjacent to the camera hole 101, but is not limited thereto.

A telephoto lens 190 may be slidably coupled to cover the camera hole 101 adjacent to the camera hole 101. The telephoto lens 190 may be slidably coupled to the case body 105 and be disposed in front of the camera 11 to cover the camera hole 101, if necessary. As described above, as the telephoto lens 190 is slidably coupled and selectively used, it is not used when it is possible to sufficiently grasp the long-range target only by the camera 11. Meanwhile, the configuration in which the telephoto lens 190 is slidably coupled is merely an example, and the telephoto lens 190 may be manufactured integrally with the main body 105, and the implementation and/or coupling form of the telephoto lens 190 is not limited thereto.

A laser module 150 is disposed adjacent to the camera hole 101 to radiate a laser beam to the target specified by the camera 11 and to receive the laser beam reflected from the target.

The laser module 150 is actually mounted on the main board of the golf distance measuring device 100, and the main board includes a control chip for implementing a controller 160 for controlling driving of the golf distance measuring device 100.

The controller 160 may include a distance calculation module for radiating a laser beam according to a command signal transferred from the outside and calculating distance information about the target by a time difference of the received laser beam.

Further, the golf distance measuring device 100 may include memory 170 capable of separately storing the distance information above or outside the main board, but is not limited thereto, and the distance information, after transferred to the application through the communication unit, may not be stored.

The connection unit 180 may be implemented with a wire 181 protruding from one end portion, e.g., one side surface, of the case and a coupling terminal 185 formed at an end of the wire 181.

The other end of the wire 181 is connected to the main board to transmit the distance information from the controller 160 to the outside through the coupling terminal 185.

The connection unit 180 may transfer power from the outside to the power supply unit 120, and may transfer a distance measurement start signal. The connection unit 180 may also transmit the distance information to the outside. In this case, the outside may be the user terminal 1, i.e., a smartphone, which is coupled to slide or fit inside the case and is used integrated with the golf distance measuring device 100.

The coupling terminal 185 of the connection unit 180 is fitted into the terminal hole 12 of the smartphone to transmit signals and power.

In this case, the coupling terminal 185 may be of a pin type, a USB-A type, or a USB-C type, but is not limited thereto.

Meanwhile, it is merely an example that the connection unit 180 is implemented with the wire 181 and the connection terminal 185 as illustrated in FIG. 2A, and there is no limitation on the implementation of the connection unit 180 for connection with the terminal. For example, as shown in FIG. 2B, the connection unit 180a may be formed on one side surface of the main body 105. For example, the connection unit 180a may be implemented as a USB-C type connector that may be mounted in a USB inlet hole of the user terminal 1 (e.g., a smartphone), but this is also merely an example, and the implementation form and/or the connection method with the user terminal 1 is not limited thereto.

Specifically, referring to FIG. 3, the golf distance measuring device 100 implemented as a smartphone case type is implemented as a laser module 150 capable of measuring a distance to a target, a controller 160, a connection unit 180, a power supply unit 120, and memory 170.

The laser module 150 includes a laser beam transmitter 151 radiating a laser beam in a corresponding direction according to a start signal and target direction information from the controller 160, and a laser beam receiver 155 receiving the laser beam that is radiated from the laser beam transmitter 151 and reflected back by the target.

The laser beam transmitter 151 and the laser beam receiver 155 may be mounted as one functional module and are disposed to be exposed to the outside of the case.

In this case, the laser module 150 may further include a cover unit (not shown) covering the laser beam transmitter 151 and the laser beam receiver 155.

The controller 160 is mounted on the main board of the golf distance measuring device 100, and the main board controls the overall driving of the golf distance measuring device 100.

The controller 160 transfers the start signal to the laser module 150 according to the start signal transferred from the outside, and receives the reception signal from the laser beam receiver 155.

The controller 160 may calculate the distance information about the target according to the time difference between the transmission signal and the reception signal, in combination of the laser transmission information and the laser reception information.

The controller 160 may transfer the distance information to be stored in the memory 170. It will be understood by one of ordinary skill in the art that the controller 160 may be implemented independently from the memory 170, or the controller 160 and the memory 170 may be configured as one according to implementation.

Further, the controller 160 may transfer the calculated distance information about the target to the user terminal 1 through the coupling terminal 185 connected through the connection unit 180.

The connection unit 180 may be implemented with a wire 181 protruding from an end portion, e.g., one side surface, of the case, and a coupling terminal 185 formed at an end portion of the wire 181, and the connection unit 180 may transfer power from the outside to the power supply unit 120 and may transfer a distance measurement start signal to the controller 160. Further, the distance information about the target may be transmitted to the external user terminal 1.

In other words, the coupling terminal 185 of the connection unit 180 is fitted into the terminal hole 12 of the smartphone, which is the user terminal 1, to transmit signals and power.

Corresponding thereto, the user terminal 1 may include an application execution unit 13, a camera 11, a communication unit 15, and a display unit 10 in the golf distance measuring system.

The application execution unit 13 may be a processor of the terminal 1, and may download an application for measuring the golf distance from the outside and may install the downloaded application in the corresponding user terminal 1. Meanwhile, as is described below in more detail, a module for measuring the distance may be included in the terminal 1.

The application execution unit 13 interworks with the golf distance measuring device 100 to measure the distance to the target, e.g., the flagstick 20, by executing the application according to the user's selection.

The application execution unit 13 may recognize the target from the camera 11 of the user terminal 1 and obtain an image of the target.

The camera 11 may be a general high-performance camera 11 for a smartphone, and such a high-performance camera 11 has the lens 190 power to sufficiently photograph the maximum distance from each hole in the golf course.

While the camera 11 specifies the target, the image of the target is displayed to the user through the display unit 10 of the user terminal 1.

The display unit 10 may be a display of a general user terminal 1, e.g., an organic electroluminescent display device or a liquid crystal display device of a smartphone, but is not limited thereto.

The display unit 10 provides the image captured by the camera 11 in real time and specifies the target in the image according to the operation of the application execution unit 13.

The target may be specified by the user selecting a part of the image, i.e., an object that appears to be the target, on the display unit 10, but may also be specified through an image processing algorithm of the application execution unit 13.

The image processing algorithm may be an AI-based algorithm, and an object attribute determination algorithm in an image within each pixel may be applied.

The image processing algorithm may use a neural network pre-trained to recognize the target flagstick 20. The neural network may include a convolutional layer. The neural network may be trained using a large number of learning images including correct answer images and incorrect answer images related to the flagstick 20. The parameters of the neural network may be trained so that the classification result of the learning images, which are the correct answer images, becomes the flagstick 20, and the classification result of the learning images, which are the incorrect answer images, is not the flagstick 20. Meanwhile, the convolution layer is merely an example, and the type of neural network is not limited. For example, the neural network may include a fully connected neural network (FCNN), a recurrent neural network (RNN), a long short term memory (LSTM), a gated recurrent unit (GRU), an attention mechanism, or the like. Meanwhile, various methods other than the neural network may be used for image recognition. For example, template matching, edge detection, corner detection, color analysis, histogram comparison, feature-based method, and morphological analysis may be used for image recognition.

In this case, the image processing algorithm may specify the color, the size, and the direction of the target.

In this case, the application execution unit 13 may receive information about each golf course, weather information, and the like from an external server, and may specify the color, size, and location information about the flagstick 20 at the corresponding hole by extracting topographic information about the corresponding golf course.

By recognizing and learning such additional information as parameters, the image processing algorithm may become more precise and faster.

The application execution unit 13 may secure information such as the distance, the curved shape, etc. for each hole by golf course information of the external server.

Depending on the topographical characteristics of each hole, the flagstick may not be visible to the naked eye when putting. In this case, the application execution unit 13 may read the map for each hole of the golf course, and recognize the position where the user stands and extract the expected distance to hit the ball.

In this case, the GPS in the user terminal 1 may be used for the location information about the user, and the GPS may have a larger error than the distance measurement by the laser module 150, and thus may be used to calculate the expected distance and the expected direction.

When the target is specified, the application execution unit 13 may transmit a start signal including the direction information about the target. In this case, the direction information about the target may be provided as specifying the target in the display unit 10. Meanwhile, in another embodiment, at least one operation for automatic distance recognition may be performed based on the target being located in a designated area (e.g., a rectangular area, but is not limited).

Further, the application execution unit 13 may compare the distance information about the target received through the communication unit 15 with the expected distance and the expected direction, correct the same, and provide it to the user through the display unit 10.

The application execution unit 13 may guide an optimal golf club and swing direction in response to the provided golf distance result.

In this case, the calculation of the golf club and the swing direction may be performed by reflecting weather and topographic information. Further, the swing power of the user may be applied through the history information about the user, and accordingly, the golf club and the swing direction may be recommended.

As described above, the golf distance measuring system obtains most of the available functions through the user terminal 1, and separately uses the laser module 150 and the golf distance measuring device 100 that performs only distance measurement through the laser module 150 by directly connecting to the user terminal 1. Accordingly, it is possible to lead to process data and execute the application as desired, using the processor of the user terminal 1 without an expensive processor.

For the display unit 10 and the high-functional camera 11, as well as the processor, it may also function as one system by coupling a cheap, simple golf distance measuring device to the user terminal 1 by using the user terminal 1.

Further, additionally, a speaker, a microphone, a wireless communication module, and a memory 170 may be utilized.

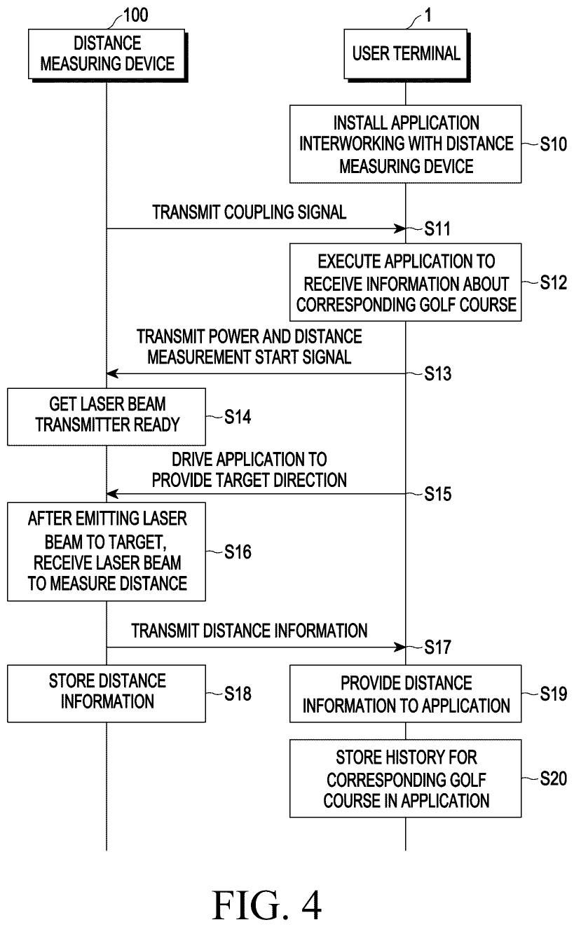

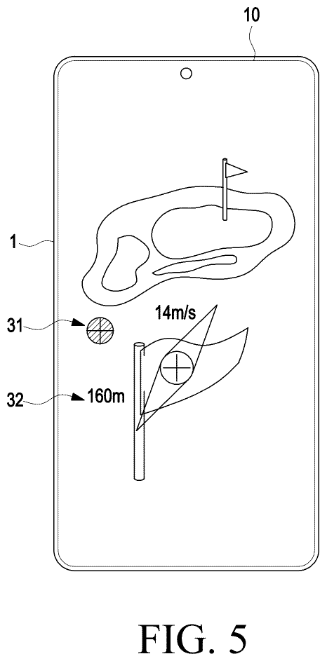

Hereinafter, the entire operation of the golf distance measuring system of the disclosure is described with reference to FIGS. 4 and 5.

The user terminal 1 downloads a corresponding application from an external server, e.g., a management server of the manufacturer or seller of the golf distance measuring system, and installs the corresponding application in the user terminal 1 (S10).

When the case-type distance measuring device 100 is physically coupled to the user terminal 1 as a case of the user terminal 1, the coupling terminal 185 is fitted into the connection hole of the user terminal 1 to lead to an electrical connection.

Accordingly, the user terminal 1 and the distance measuring device 100 may be driven as one module.

When the application is executed from the user, a coupling signal is received from the distance measuring device 100 (S11). Alternatively, the user terminal 1 may identify the distance measuring device 100 based on a load change in the terminal to which the distance measuring device 100 is connected. Alternatively, the user terminal 1 may identify that the distance measuring device 100 is connected by receiving the identification information from the distance measuring device 100.

The user terminal 1 may execute the application to receive information about a corresponding golf course, and may receive weather information, e.g., weather information, the wind direction, and wind strength information (S12).

Further, the user terminal 1 may execute the application to record game-related information input by a user input. The application may analyze the recorded log and provide a game analysis result for the user. The game-related information may include the type of golf club used, the field type of the corresponding location, temperature, air pressure, altitude, humidity, wind direction, etc. at the corresponding location and time.

When a corresponding hole is selected in the application, an operation for specifying a target is started.

The user terminal 1 transmits power and a distance measurement start signal to the distance measuring device 100 through the connection unit 180 (S13).

When the distance measuring device 100 receives power from the connection unit 180, the distance measuring device 100 supplies power required for each unit through the power supply unit 120.

When the controller 160 receives the distance measurement start signal, the controller 160 transfers the start signal to the laser module 150 to get the laser beam transmitter 151 ready (S14).

Meanwhile, the user terminal 1 operates the camera 11 for obtaining a target image.

The user terminal 1 drives the camera 11 to obtain the image of the target and provides the image to the display unit 10 in real time.

In this case, the camera 11 may be a general high-performance camera 11 for a smartphone, and such a high-performance camera 11 has the lens 190 power to sufficiently photograph the maximum distance from each hole in the golf course. However, when the power of the lens 190 is insufficient, the power of the lens 190 may be enhanced by sliding the telephoto lens 190 mounted on the case and disposing the telephoto lens 190 on the front surface of the camera 11.

While the camera 11 specifies the target, the image of the target is displayed to the user through the display unit 10 of the user terminal 1.

The display unit 10 provides the image captured by the camera 11 in real time and specifies the target, e.g., the flagstick 20, in the image according to the operation of the application execution unit 13.

The target may be specified by the user selecting a part of the image, i.e., an object that appears to be the target, on the display unit 10, but may also be specified through an image processing algorithm of the application execution unit 13.

The image processing algorithm may be an AI-based algorithm, and an object attribute determination algorithm in an image within each pixel may be applied.

The image processing algorithm may specify the color, the size, and the direction of the target.

In this case, the application execution unit 13 may receive information about each golf course, weather information, and the like from an external server, and may specify the color, size, and location information about the flagstick 20 at the corresponding hole by extracting topographic information about the corresponding golf course.

When the target is specified in the image displayed on the display unit 10, information about the target, specifically target direction information, is transmitted to the distance measuring device 100 (S15).

The distance measuring device 100 may receive the target direction information, and the camera 11 of the user terminal 1 and the laser beam transmitter 151 of the golf distance measuring device 100 may be matched according to the target direction information. Accordingly, the radiation point of the laser beam transmitter 151 of the golf distance measuring device 100 and the display of the target displayed on the display unit 10 of the user terminal 1 may be matched.

In this case, the location of the camera 11 of the user terminal 1 and the location of the laser beam transmitter 151 in the case physically coupled thereto may vary depending on the model of the user terminal 1, so when the model of the user terminal 1 is received, the golf distance measuring device 100 may perform adjustment accordingly.

For example, when the model code of the user terminal 1 is transmitted through the connection unit 180, the adjustment parameter for the locational relationship of the golf distance measuring device 100 may be selected to enable adjustment.

When the golf distance measuring device 100 is matched with the user terminal 1, a laser beam is emitted in the target direction (S16).

Next, the laser beam reflected from the target is received by the laser beam receiver 155, and a time difference from the laser beam emission time to the receiving time is calculated to calculate the distance to the target.

The golf distance measuring device 100 or 110 may measure the distance using a time of flight (TOF) method using the traveling time of the laser beam. The golf distance measuring device 100 may measure the distance using a phase shift method or a frequency-modulated continuous wave (FMCW) method using the phase difference of the laser beam.

Information about the calculated target distance is transmitted to the user terminal 1 through the connection unit 180 (S17).

The user terminal 1 may obtain information such as the distance, the curved shape, or the like for each hole by golf course information of an external server, may read the map of the corresponding hole of the corresponding golf course, may recognize the location where the user stands, and may calculate the expected distance that the user intends to hit.

The application execution unit 13 obtains target distance information and compares the measured target distance with the expected distance.

When an error between the measured target distance and the expected distance is larger than or equal to a threshold, the distance measurement may be performed again to reduce the error range.

When the measured distance information meets within the threshold, the measured target distance is determined as the final target distance, and the distance information and the target direction are processed and provided to the display unit 10 (S19).

The target distance information provided to the display unit 10 may be as shown in FIG. 5, but is not limited thereto.

Referring to FIG. 5, the current hole of the corresponding golf course is approximately illustrated on the display unit 10 of the user terminal 1, and the direction of wind, the speed, and the target location, i.e., the target distance 32 and the target direction, are displayed as the target icon 31 based on the current location.

The user may swing the golf club according to the target information.

In this case, the display unit 10 may provide a recommended golf club and swing direction, and may also provide a simulated swing motion.

Next, the user terminal 1 ends the golf distance measurement operation for one hole by storing the swing history of the corresponding golf course (S20).

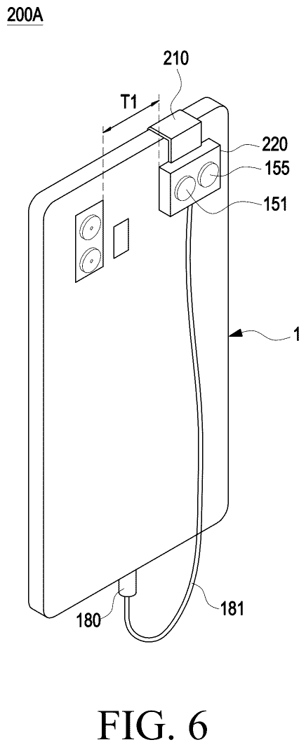

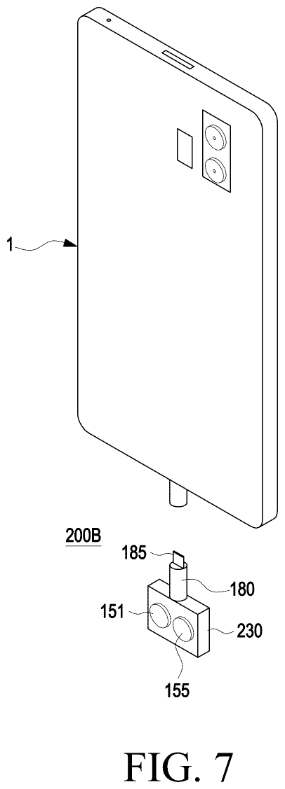

Hereinafter, various application examples of the golf distance measuring device 100 matching with the user terminal 1 to constitute the golf distance measuring system are described with reference to FIGS. 6 and 7.

FIG. 6 is a view schematically illustrating a golf distance measuring device 200A according to a second embodiment of the disclosure.

In the golf distance measuring device 200A according to the second embodiment, all of the functional units of FIG. 3 may be mounted on the main board, and the golf distance measuring device 200A may be composed of a single module 220 where a laser beam transmitter 151 and a laser beam receiver 155 for radiating and receiving a laser beam are exposed to the outside.

The golf distance measuring device 200A according to the second embodiment may be implemented as a hexahedral module 220 coupled, as a clip type, to a smartphone or the like, which is the user terminal 1, so that the laser beam transmitter 151 and the receiver 155 are disposed in parallel to the rear surface of the terminal 1, i.e., the surface on which the lens of the camera 11 is exposed, but it will be understood by one of ordinary skill in the art that the implemented shape is not limited thereto. Further, the shape, size, and/or location of the bracket 210 are not limited.

The golf distance measuring device 200A may include a bracket 210 that surrounds a horizontal side surface of an upper portion of the user terminal 1 and may be clipped, and the hexahedral module 220 is attached to an end of the bracket 210.

When the user terminal 1 and the golf distance measuring device 200A are physically coupled to each other by the bracket 210, the wire 181 and the connection terminal 185 extending from the lower surface of the hexahedral module 220 may be inserted into the input hole 12 of the user terminal 1 for electrical coupling.

Accordingly, the wire 181 may be provided in an extendable state so as to be electrically coupled according to the location of the input hole 12 of the user terminal 1.

Further, the clip-type golf distance measuring device 200A may be coupled to any location on the side surface of the user terminal 1, but may transmit a test laser signal for matching with the camera 11 due to the randomness of the distance Tl between the user terminal 1 and the camera 11.

The distance Tl to the camera 11 may be determined by transmitting and receiving the test laser signal, and the matching parameter may be corrected accordingly.

FIG. 7 is a view schematically illustrating a golf distance measuring device 200B according to a third embodiment of the disclosure.

The golf distance measuring device 200B according to the third embodiment of the disclosure may be manufactured as one hexahedral module 230 like the golf distance measuring device 200A of FIG. 6, but the shape thereof is not limited thereto.

The golf distance measuring device 200B of FIG. 7 includes a connection unit 180 having one end extending from one integrated module 230. The connection unit 185 includes a wire therein, and the other end portion thereof is connected to the coupling terminal 185.

The coupling terminal 185 may be variously implemented according to the user terminal 1 and may be variously implemented as a pin type, a USB-A type, a USB-C type, or the like.

The golf distance measuring device 200B of FIG. 7 is physically coupled by directly inserting the coupling terminal 185 into the connection hole 12 of the smartphone. Therefore, it is possible to integrate with the user terminal 1 only by couple the terminal without a separate fixing module. Further, when the coupling terminal 185 is coupled, the laser module 150; 151, 155 is coupled to be disposed on the same plane as the camera 11, and the configuration is not limited thereto.

Further, the golf distance measuring device according to the disclosure may be implemented as a single module, and when coupled to the user terminal 1, the golf distance measuring device may be formed in an attachable grip type to be attached to the rear surface of the user terminal 1 and used. Even in the case, the coupling terminal of the connection unit is inserted into the connection hole of the smartphone, so that physical and electrical coupling may be completed.

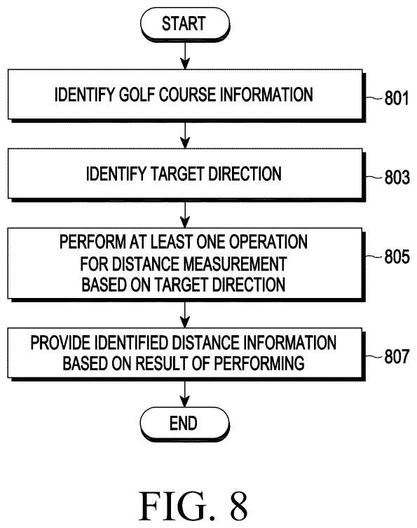

FIG. 8 is a view illustrating a method of operating an electronic device according to an embodiment.

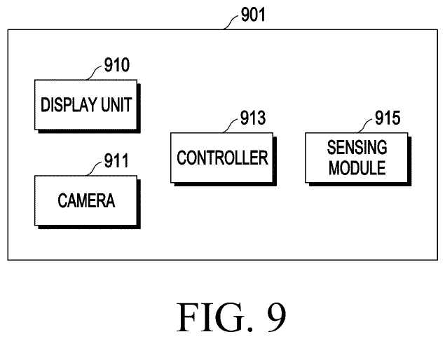

According to an embodiment, in operation 801, the electronic device 901 of FIG. 9 may identify information about the golf course. The electronic device 901 may be implemented as, e.g., a terminal such as a smartphone, or a wearable device such as a smart glasses-type device, a smart goggle device, a smart lens, a smart watch, or an HMD. The detailed configuration of the electronic device 901 is described in more detail with reference to FIG. 9. The electronic device 901 may receive golf course information in real time based on, e.g., wireless communication, and/or may identify golf course information (e.g., fixed information (or static information)) stored as application information. The information about the golf course may include information related to the golf course, e.g., a golf course, geographical characteristics of each hole (for example, grass length, altitude, or obstacle information such as bunker, etc.), and user history information about the golf course, but the type of the information is not limited thereto. It will be understood by one of ordinary skill in the art that dynamically changing weather information and wind direction information may be received in addition to geographical characteristics.

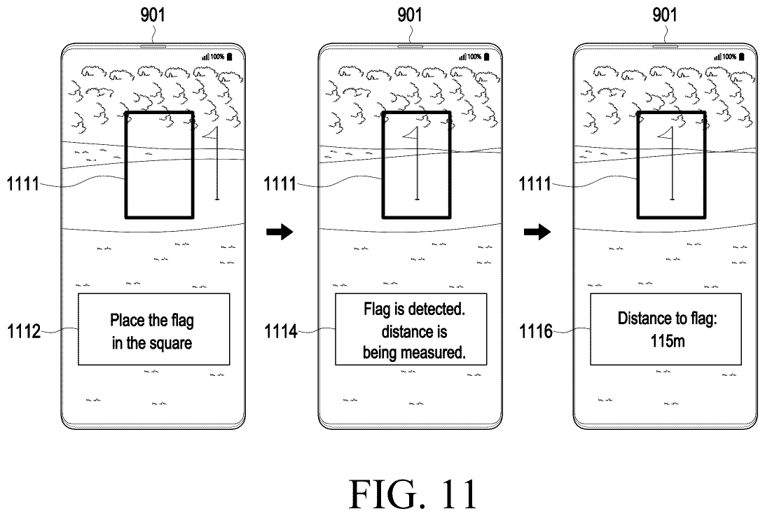

In operation 803, the electronic device 901 may identify the target direction. In operation 805, the electronic device 901 may perform at least one operation for distance measurement based on the target direction. For example, the electronic device 901 may perform at least one operation for laser beam radiation and at least one operation for receiving the reflected laser beam as at least one operation for distance measurement, but this is exemplary. It will be understood by one of ordinary skill in the art that the electronic device 901 may measure the distance based on radiation of ultrasonic waves and reception of reflected ultrasonic waves, and the method for measuring the distance is not limited thereto. It will be understood by one of ordinary skill in the art that the electronic device 901 may measure the distance by comprehensively (or complementarily) performing a plurality of distance measurement methods. Alternatively, the electronic device 901 may measure the distance using both an image analysis-based distance measurement method and a sensing method (e.g., a laser-based distance measurement method). For example, the image analysis-based distance measurement method may identify the distance to the flagstick based on the size of the object corresponding to the flagstick in the captured image, but this is exemplary. It will be understood by one of ordinary skill in the art that there is no limitation on the characteristics of the image (or the object in the image) used for distance measurement other than the size of the object. In one example, the electronic device 901 may identify the target direction based on image analysis. For example, the electronic device 901 may identify that the electronic device 101 faces the target based on detection of the object corresponding to the flag in a designated area within the captured image (e.g., a preview image, but not limited thereto), which is described with reference to FIG. 11. For example, the electronic device 901 may include a camera 911 and a sensing module 915 as illustrated in FIG. 9, and the positions of the camera 911 and the sensing module 915 in the electronic device 901 may be fixed. Accordingly, the designated area within the area captured by the camera 911 may mean an area capable of sensing (or having high sensing accuracy) by the sensing module 915. Accordingly, the electronic device 901 may identify that the electronic device 901 faces the target based on identifying that the object corresponding to the flag is included in the designated area in the image captured by the camera 911. Meanwhile, based on the object corresponding to the flag being detected from the captured image, the electronic device 901 may identify that the electronic device 901 faces the target. Alternatively, the electronic device 901 may identify whether the electronic device 901 faces the target using the golf course information. For example, the electronic device 901 may identify the current direction of the electronic device 901 based on a gyro sensor and/or a geomagnetic sensor. The electronic device 901 may identify the hole location from the current location based on the topographic information included in the golf course information, and thus may identify the target direction. Based on the comparison result between the direction in which the electronic device 901 is currently facing and the identified direction, it may be identified whether the electronic device 901 is currently facing the target.

Meanwhile, the electronic device 901 may perform distance measurement based on trigonometry. The triangulation method may refer to a method of determining the accurate location of a third point by measuring the distance between two points and the angle from two points to the third point. In this case, a triangle is formed using the distance between the two points and the angle observed at the two points, and the distance of the image may be calculated using the properties of the triangle. For example, the electronic device 901 may measure distances at two points, respectively. The distance between the two points may be referred to as a baseline distance. Further, the electronic device 901 may measure the angle from both end points (i.e., two points) of the baseline to the target point. Angle measurement may be performed based on, e.g., theodolite, but is not limited thereto. The electronic device 101 may measure the distance based on trigonometry based on the baseline distance and the angle to the target point. Meanwhile, the trigonometry may be used when an obstacle (e.g., a tree, but not limited thereto) is located between the electronic device 901 and the target point. For example, a straight distance and a parabolic distance may be provided together by calculating the parabolic distance by identifying the height of a tree (or topographic feature). Except when putting, it is useful to provide the parabolic distance in that the trajectory of the golf ball is mostly parabolic.

Meanwhile, the electronic device 901 may correct the measured distance based on the user's height (body size) and/or altitude difference. In other words, the electronic device 901 may perform distance correction considering an error in the z-axis direction. For example, the electronic device 901 may use a geometric correction method. The geometric correction method may also be a method using triangulation in the z-axis direction. For example, the distance to the target point, directly measured by the electronic device 901 may be referred to as a “slant distance”. Further, the distance from the point where the electronic device 901 is located to the target point may be referred to as a “horizontal distance”. The distance to the target location needs to be measured as a “horizontal” distance. The electronic device 901 may measure or receive, e.g., a height from the ground. The height from the ground to the electronic device 901 may be a difference in altitude, and accordingly, the corrected distance, i.e., the “horizontal distance”, may be expressed as Equation 1.

$$HD = \sqrt{{S}^{2} - {A}^{2}} \qquad Equation 1$$

Where HD stands for a horizontal distance, S stands for a slant distance, and A stands for an altitude difference.

The electronic device 901 may identify the “horizontal distance”, which is the corrected distance, based on the measured slant distance and the identified altitude difference.

It will be understood by one of ordinary skill in the art that the target point may be various locations (e.g., a point desired by the user) as well as the location of the flag. For example, the electronic device 901 may receive a user input for selecting the desired point, and may identify the target point based on the user input.

Meanwhile, the laser sensor may be implemented in various shapes, such as a shape extending in a vertical direction, a shape extending in a horizontal direction, a circular shape, an elliptical shape, or the like.

In operation 807, the electronic device 901 may provide distance information identified based on the execution result. For example, the electronic device 901 may simply provide information about the distance to the flag. Alternatively, the electronic device 901 may further provide additional information such as distance information, wind direction information, and golf course characteristic information. The additional information may be derived from, e.g., golf course information, but the derivation method is not limited. Alternatively, the additional information may include the golf club type, the swing direction, and the swing method corresponding to the derived distance.

FIG. 9 is a view schematically illustrating a golf distance measuring device according to a fourth embodiment of the disclosure.

According to an embodiment, the electronic device 901 may include a display unit 910, a camera 911, a controller 913, and/or a sensing module 915.

The display unit 910 may be implemented as an LCD module capable of displaying a screen. For example, when the electronic device 901 is implemented as a smartphone, the display 910 may be implemented to further include, e.g., a touch panel, and in this case, the display 910 may be referred to as a touch screen. It will be understood by one of ordinary skill in the art that when the electronic device 901 is implemented as smart glasses or an HMD, the display 910 may be implemented to include, e.g., a projector for displaying a screen and/or an optical waveguide.

The camera 911 may be implemented to provide an image by capturing, e.g., external light. It will be understood by one of ordinary skill in the art that the number of cameras 911 is not limited, and the positions of the cameras 911 are not limited.

The controller 913 may include a CPU, a GPU, an NPU, a DPU, an FPGA, an ASIC, and/or an SoC, and the implementation form thereof is not limited. For example, according to an embodiment, one operation performed by the electronic device 901 and/or the server may be performed by any one of at least one controller (e.g., CPU, GPU, NPU, FPGA, ASIC, and/or SoC), or may be performed in association with two or more controllers. For example, according to an embodiment, a plurality of operations performed by the electronic device 901 may be performed by any one of at least one controller (e.g., CPU, GPU, NPU, FPGA, ASIC, and/or SoC), or some of the plurality of operations may be performed by any one controller and the remaining some may be performed by another controller. For example, the electronic device 901 may include at least one memory storing at least one instruction. The at least one memory may include volatile memory and/or non-volatile memory, but is not limited thereto. The at least one instruction may, when executed by at least one controller, enable the electronic device to perform at least one operation (e.g., at least some of the operations performed by the electronic device described in the disclosure). The instructions enabling the electronic device 901 to perform one operation or a plurality of operations may be stored in one physically independent memory, or may be distributed and stored in a plurality of memories. Meanwhile, the at least one controller may operate based on an inference of an artificial intelligence model.

The sensing module 915 may include, e.g., at least one module for measuring the distance. As described above, the sensing module 915 may be implemented to include a laser beam radiation module for radiating a laser beam and a laser beam reception module (or an optical sensor) for receiving the reflected laser beam. Meanwhile, a method for measuring the distance based on a laser is exemplary, and it will be understood by one of ordinary skill in the art that the sensing module 915 may be implemented to include an ultrasonic transmitter and an ultrasonic receiver, and the type thereof is not limited thereto. The sensing module 915 may further include a gyro sensor and/or a geomagnetic sensor for determining the direction in which the electronic device 901 faces. The sensing module 915 may be implemented to further include a module (e.g., a GPS module) capable of identifying the current location of the electronic device 901.

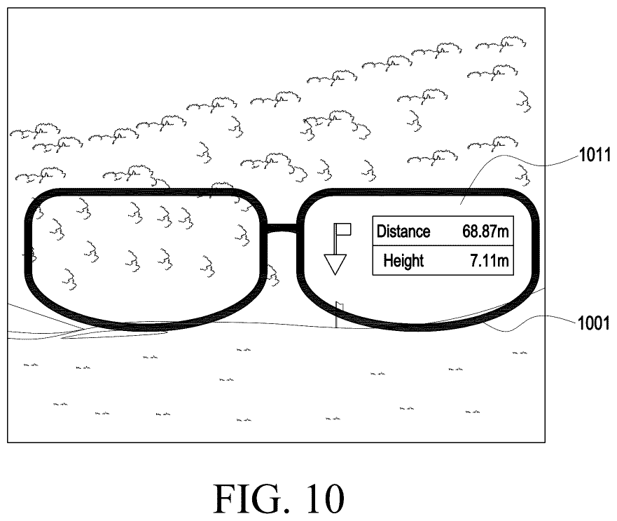

FIG. 10 is a view schematically illustrating a golf distance measuring device according to the fourth embodiment of the disclosure.

According to an embodiment, the electronic device 1001 may be implemented as a smart glasses device. The smart glasses device may include, e.g., a transparent display, or may include a projector and an optical waveguide, and may thus display distance-related information 1011 as shown in FIG. 10. As described above, the electronic device 1001 may measure the distance to the flag by performing at least one operation for distance measurement based on the electronic device 1001 facing the target. The electronic device 1001 may display information 1011 about the identified distance to the flag. The display location of the information 1011 may be displayed corresponding to, e.g., the identified flag (or laser beam radiation direction), but the display location is not limited thereto.

FIG. 11 illustrates an example of a screen displayed according to the disclosure.

According to an embodiment, the electronic device 901 may display a graphic object 1111 indicating a designated area in the image 1110. The area corresponding to the graphic object 1111 may correspond to, e.g., a sensing range of the sensing module 915. As described above, the location of the camera 911 in the electronic device 901 and the location of the sensing module 915 in the electronic device 901 are fixed. Accordingly, the relative location between the camera 911 and the sensing module 915 may also be fixed. In other words, the sensing range (e.g., the range in which laser beam radiation is possible) of the sensing module 915 may be fixed in the image of the camera 911. Accordingly, the electronic device 901 may display text 1112 such as “please place the flag in the square.” The user may identify the text 1112 and change the photographing direction of the electronic device 901.

If it is identified that the flag is located in the graphic object 1111, the electronic device 901 may display the text 1114 “Flag was detected. Distance is being measured.” The electronic device 901 may perform at least one operation for distance measurement based on identifying that the flag is located in the graphic object 1111. For example, the electronic device 101 may control the sensing module 915 to radiate a laser beam. The electronic device 101 may receive the reflected laser beam. The electronic device 101 may identify the distance by, e.g., identifying the TOF, but the identification method is not limited thereto.

Accordingly, the electronic device 101 may provide the text 1116 indicating the identified distance. For example, the user may identify the distance by identifying the text 1116. As described above, it will be understood by one of ordinary skill in the art that the electronic device 101 may further display additional information such as wind direction information, swing-related information (e.g., swing direction), and golf club-related information.

Meanwhile, the above-described example is merely an example. When it is identified that the flag is located in the graphic object 1111, the electronic device 101 may immediately perform at least one operation for distance measurement without a user input. Accordingly, it is possible to minimize the error caused by the user's hand shake.

Embodiments of the disclosure have been described above with reference to the accompanying drawings, but are merely an example.

It will be understood by one of ordinary skill in the art that various changes in form and detail may be made thereto without departing from the spirit and scope of the disclosure as defined by the following claims.

What is claimed is:

1. A golf distance measuring device, comprising:
a main body formed outside a user terminal;
a laser beam transceiver, formed in the main body, configured to:
perform transmission/reception with the user terminal, and
receive a direction of a target from the user terminal to transmit/receive a laser beam to/from the target; and
a controller, formed in the main body, configured to:
receive laser transmission/reception information from the laser beam transceiver, and
calculate a distance to the target based on the laser transmission/reception information.

2. The golf distance measuring device of claim 1, wherein the golf distance measuring device receives the target direction by specifying the direction of the target from a camera of the user terminal in conjunction with the user terminal.

3. The golf distance measuring device of claim 2, further comprising:
a coupling terminal exposed to an outside from one end of the main body and inserted into a terminal hole of the user terminal,
wherein the coupling terminal is configured to:
transfer power from the user terminal to the golf distance measuring device,
transfer a target distance measurement start signal, and
transmit the calculated target distance to the user terminal.

4. The golf distance measuring device of claim 3,
wherein the user terminal installs and executes an application interworking with the golf distance measuring device, and
wherein an image of the target, captured by the camera, is displayed, in real time, on a display unit of the user terminal.

5. The golf distance measuring device of claim 4,
wherein the user terminal receives geographic information about a current golf course from a golf course server, and
wherein the user terminal receives specifies the target in the image of the target based on the geographical information.

6. The golf distance measuring device of claim 5,
wherein the user terminal transmits the target direction to the controller through the coupling terminal, and
wherein the controller instructs the laser beam transceiver to emits the laser beam in the target direction.

7. The golf distance measuring device of claim 6,
wherein the laser beam transceiver receives the laser beam reflected from the target, and
wherein the controller calculates the target distance according to a laser beam transmission/reception time difference.

8. The golf distance measuring device of claim 7, wherein the user terminal processes and displays the target distance on the display unit through the application.

9. The golf distance measuring device of claim 1,
wherein the golf distance measuring device is a terminal case in which the main body receives the user terminal and protects the user terminal from an outside,
wherein a camera hole is formed in the terminal case to expose the camera of the user terminal, and
wherein the golf distance measuring device further comprises a telephoto lens covering the camera hole while sliding.

10. The golf distance measuring device of claim 1, further comprising:
a bracket fastened to at least one surface of the user terminal and having one end connected to the main body,
wherein the golf distance measuring device is clipped to the user terminal by the bracket.

11. A method for operating an electronic device, the method comprising:
identifying whether the electronic device faces a target based on first sensing data obtained through at least one first sensing module included in the electronic device and/or an image obtained through a camera included in the electronic device;
identifying a distance from the electronic device to a location of the target based on second sensing data obtained through at least one second sensing module included in the electronic device, based on identifying that the electronic device faces the target; and
providing information about the identified distance.

12. The method of claim 11, wherein the target location is a location designated by a golf flag or a user.

13. The method of claim 11, wherein the identifying of the distance from the electronic device to the target location includes:
radiating a laser beam;
receiving a reflected laser beam generated based on the radiated laser beam; and
identifying the distance to the target location based on a difference between a radiation time and a reception time.

14. The method of claim 11, wherein the identifying of the distance from the electronic device to the target location includes identifying the distance to the target location based on triangulation.

15. The method of claim 11, wherein the identifying of the distance from the electronic device to the target location includes correcting the distance to the target location based on a body size of a user of the electronic device and/or an altitude difference between the electronic device and the target point.

16. The method of claim 11, wherein the identifying whether the electronic device faces the target includes identifying that a target object associated with the target direction is located in a designated area in an image collected by the electronic device.
